(19) United States
(12) Patent Application Publication
(10) Pub. No.: US 2007/0149176 A1
(43) Pub. Date: Jun. 28, 2007

(54) Method and system to communicate a voice mail indication in a loosely coupled environment

(75) Inventors: Kevin L. Wells, Plantation, FL (US); Jose E. Korneluk, Lake Worth, FL (US); Satish Ramprasad, Boynton Beach, FL (US); Srinath Subramanian, Davie, FL (US); Frederick L. Kampe, Boynton Beach, FL (US); Richard Wendelken, Parkland, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/320,351

(22) Filed: Dec. 28, 2005

(51) Int. Cl. H04Q 7/22

(52) U.S. Cl. 455/412.2

(57) ABSTRACT

A system (100) and method (400) is provided for email notification for use with a mobile device roaming in a loosely coupled network. The method can include receiving (402) a voice mail on a first network, generating (404) a voice mail indication, and sending (416) the voice mail indication through the second network to a mobile device. The voice mail indication can include encrypted information containing a phone number, an IMEI, or an IP address of the mobile device to properly route the message. The voice mail indication can include a sequence number, timestamp, or token to determine if a voice mail is stale. The method can include emailing (418) the voice mail indication to the mobile device.

### FIELD OF THE INVENTION

The embodiments herein relate generally to methods and systems for wireless communications, and more particularly mobile networking.

### DESCRIPTION OF THE RELATED ART

A loosely-coupled system can be defined as the combination of two networks that do not provide direct access to each other's internal servers. For example, a Short Message Peer to Peer (SMPP) server in a Global Systems Mobile (GSM) network cannot directly communicate with another SMPP server on an outside network. Most GSM networks contain SMPP servers for sending special Short Message Service (SMS) messages to handsets that are active on the network. However, most GSM networks do not allow an outside network to access to their SMPP servers without a prior communication agreement.

Many cell phones can support dual mode operations which allow the phone to communicate over multiple networks such as iDEN, GSM, CDMA, and WLAN. However, the phones are generally limited to using only one network at a time to transmit and receive information. The phones generally stay active on a network unless the user moves into a new coverage area or the user actually requests a service on another network.

Occasionally, a first network such as a Wide Local Area Network (WLAN) needs to send an indication to a second network such as GSM in order to deliver a message to the cell phone while the cell phone is active on the second network. For example, the cell phone may receive a voice mail from a first network while the cell phone is active on a second network. The cell phone may not be aware that a voice mail has been received on the first network when the networks are loosely coupled. For example, a WLAN network may need to notify a cell phone on a GSM network that a voicemail has arrived. However, the WLAN network cannot directly communicate the message to the cell phone since the WLAN infrastructure does not have access to the GSM SMPP server in a loosely coupled system. Accordingly, a user of the phone may not receive the voice mail until a future time when the cell phone enters a service area or the user manually requests a service supported by the second network. Alternatively, the user may receive a voice mail indication for a stale voice mail; that is, a voice mail that has already been read or received. The user may perceive the delay in receiving the emails or the improper ordering of voice mails as an annoyance and a poor quality of service by the network provider or the cell phone manufacturer.

### SUMMARY

The embodiments of the invention concern a method and system for email notification for use with a mobile device roaming in a loosely coupled network. The method can include receiving a voice mail on a first network, generating a voice mail indication on the first network, and sending the voice mail indication from the first network to the second network for informing the mobile device that a voice mail is available on the first network. The first network can determine that the mobile device is active on the second network. In one arrangement, an IP address of the mobile device on the second network can be determined, and used for sending the voice mail identification.

The voice mail indication can be addressed by including the network from which the voice mail originated. This information can be embedded into the voice mail indication for properly routing the voice mail indication. At least one of a phone number, an IMEI, or an IP address of the mobile device receiving the voice mail indication can also be embedded and encrypted in the voice mail indication. The method can include embedding a sequence number, timestamp, or token into the voice mail indication for producing embedded information to identify a stale voice mail. In one arrangement, the voice mail indication can be sent via email using an IP address of the mobile device for notifying a user of the mobile device that a voicemail has been received on the first network.

Embodiments of the invention also concern a mobile device for receiving the voice mail indication. The mobile device can include a receiver for receiving a voice mail indication, a decoder for determining an originating network of a voice mail associated with the voice mail indication, and a user interface for indicating a number of voice mails received on an originating network in view of the voice mail indication. The decoder can determine an originating network of the voice mail using the voice mail indication, and determine whether the voicemail indication is stale.

The mobile device can include a user interface for presenting at least one icon associated with an originating network of the voice mail in view of the voice mail indication. A display on the user interface can indicate to a user how many voice mails are available and in which originating network the voice mails are available. The icon can exhibit a flashing behavior, an audible behavior, or textual behavior for notifying a user that a voice mail is available on a network. The mobile device can switch to an originating network of the voice mail message in view of the voice mail indication for retrieving the voice mail.

Embodiments of the invention also concern a system for voice mail notification. The system can include a first network for generating and sending a voice mail indication, and a second network for receiving the voice mail indication. The second network can inform a mobile device that is active on the second network that a voice mail is available on the first network. The first network can embed a sequence number, timestamp, or token into the voice mail indication which can be used to determine if a voice mail is stale. The second network can inform a mobile device by sending a voice mail indication to an IP address that is assigned to the mobile device by the second network. For example, the first or second network can email the voice mail indication to the mobile device on second network using the IP address of the mobile device for notifying a user of the mobile device that a voicemail has been received on the first network.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a loosely coupled environment for voice mail notification in accordance with an embodiment of the inventive arrangements;

FIG. 2 illustrates a loosely coupled environment for voice mail notification for the condition that a mobile device is not active in accordance with an embodiment of the inventive arrangements;

FIG. 3 depicts a flowchart for voice mail notification in accordance with an embodiment of the inventive arrangements;

FIG. 4 presents a method for voice mail notification in a loosely coupled environment in accordance with an embodiment of the inventive arrangements; and

FIG. 5 continues the method of FIG. 4 in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiments herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “stale message” is defined as a message that has already been received, listened to, or processed.

The terms “program,” “software application,” and the like as used herein, are defined as a sequence of instructions designed for execution on a computer system. A program, computer program, or software application may include a subroutine, a function, a procedure, an item method, an item implementation, an executable application, an applet, a servlet, a source code, an item code, a shared library/dynamic load library and/or other sequence of instructions designed for execution on a computer system.

Embodiments of the invention concern a system and method for email notification between networks in a loosely coupled system. A voice mail indication can be sent from a first network to a second network to inform a mobile device on the second network that a voice mail has been received on the first network. The first network can determine that the mobile device is active on the second network and identify an IP address of the mobile device for sending the voice mail identification. The method can include embedding information such as the phone number, IMEI, IP address, or other identifying information into the voice mail indication such that the destination network can properly route the voice mail indication. The embedded information can be encrypted to prevent spoofing of voice mail indications by third parties. The method can further include embedding a sequence number, timestamp, or other token into the message such that the mobile device can determine whether or not the voicemail indication is stale. An additional identifier can be embedded thereby identifying the originating network of the voice mail. For example, the identifier can enumerate the voice mail networks such as 1 for GSM, 2 for iDEN, and 3 for WLAN. The method can further include presenting a different icon in a display on the mobile device for each network. The icon can flash, produce text messages, or audibly generate alerts to inform a user that a voice mail is available on a network. The method can include automatically identifying the correct location of the voice mail to retrieve voicemail or other message based on the embedded information. For example, the method can include automatically calling a WLAN network voicemail number or the GSM network voicemail number and optionally switching to the correct network if required to retrieve the voice mail. While the present embodiments of the invention disclose an implementation of the voice mail notification using a GSM/WLAN, the solution can be similarly extended to IDEN+GSM, IDEN+CDMA, CDMA+WLAN, CDMA+GSM or other loosely coupled network systems.

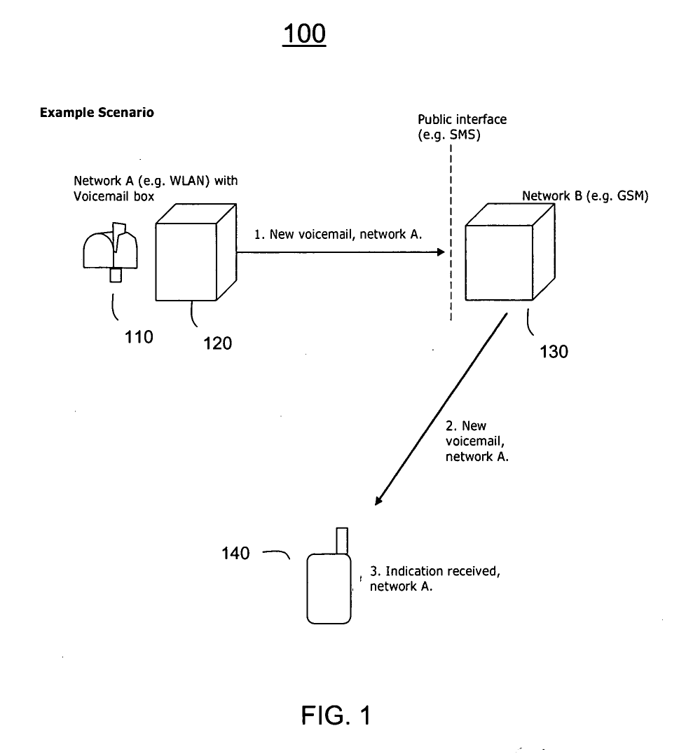

Referring to FIG. 1, a loosely coupled networking environment 100 is shown. The loosely coupled networking environment 100 can include a first network 120 (Network A) and a second network 130 (Network B). Network A 120 and Network B 130 can communicate over a radio frequency (RF) communication channel or over a Wireless Local Area Network (WLAN), or other standard communication link. Network A 120 and Network B are each capable of communicating with a mobile device 140. The mobil device 140 may be active on only one network at a time. The mobile device can include a receiver 141 for receiving a voice mail indication, a decoder 142 for determining an originating network of a voice mail associated with the voice mail indication, and a user interface 143 for indicating a number of voice mails received on an originating network in view of the voice mail indication.

The first network 120 can include a server, such as a SMPP server that can host a message service 110 for sending messages to the mobile device 140. A mobile device active on Network A can receive message indications from the message service 110 . When the mobil device 140 is active on Network B the mobile device may not be able to receive messages from the host message service 110 from Network A. Network A and Network B are “loosely coupled”. Consequently, Network B may not allow system-specific messages such as a message waiting indication to be transferred from Network A to Network B.

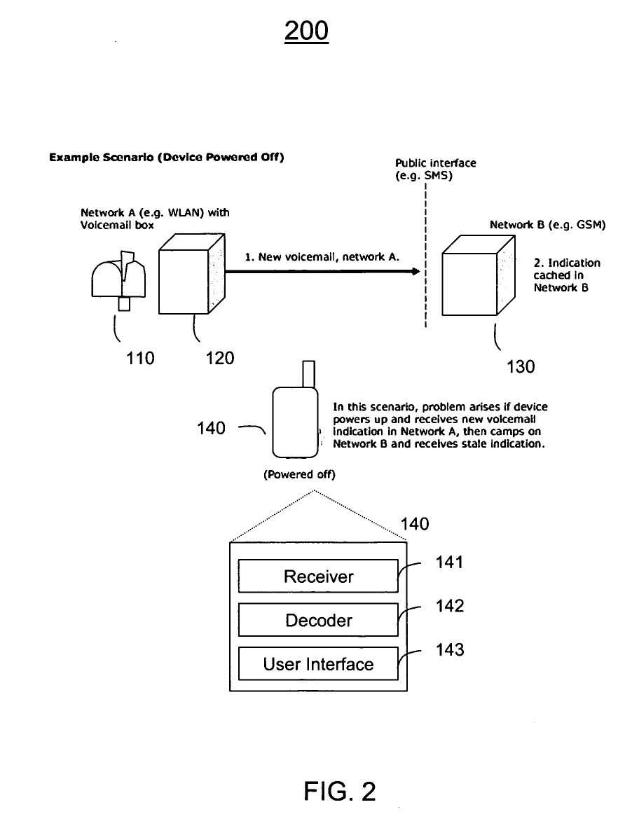

Referring to FIG. 2, an illustration of the loosely coupled environment of FIG. 1 is shown for a particular situation when the mobil device 140 is turned off. In this situation, incoming voicemail or other message for the mobile device 140 may still be received on Network A. However the mobil device 140 may be off or not active on Network A. Network A can determine that the phone is not registered with Network A and sends a message to Network B. Network B caches the message from Network A to send to the mobil device 140 the next time the mobil device 140 is active on Network B. Accordingly, Network B stores a cached message indication that will be sent to the mobile device 140. However, the mobile device may be first active on Network A, and receive the same or more recent indication of the message available on Network A. When the mobile device 140 activates on Network B, the cached message indication may refer to a stale message.

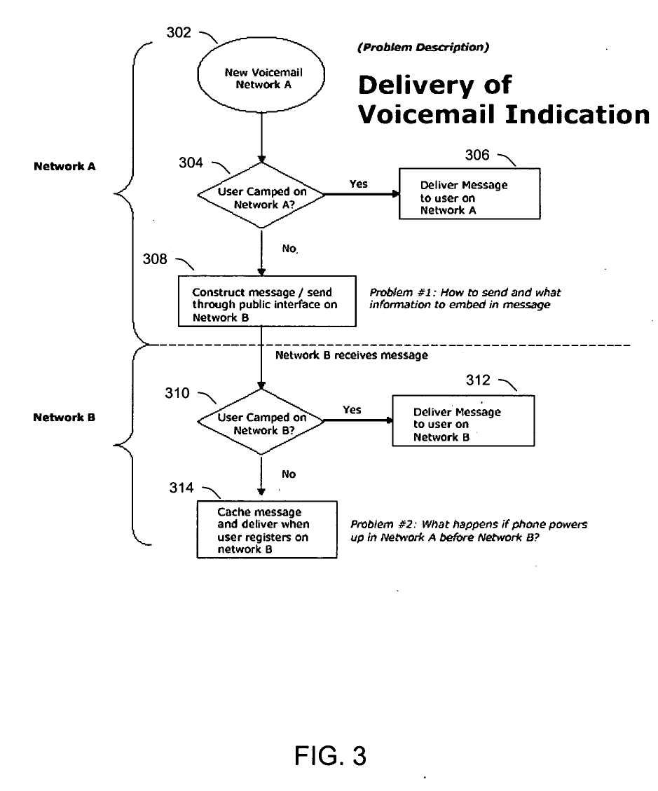

Referring to FIG. 3, a flowchart for voice mail notification in a loosely coupled environment is shown. For example, at block 302, a new voice mail is received on Network A. At block 304, a determination is made as to whether the intended recipient of the voice mail (e.g. mobile device) is active on Network A. At block 306, if the mobile device is active on Network A, a voice mail indication is sent to the mobile device. However, at block 308, if the mobile device is not active on Network A, a message is sent to the network for which the mobile device is active. Accordingly, Network A may identify Network B as actively hosting the mobile device, and sends a message to that network for informing the mobile device that a voice mail is available on Network A. Alternatively, Network A may not know which network is hosting the mobile device, and sends the message to a broad list of networks that may be hosting the mobile device. Without the invention, a problem arises for determining how to send and what information to embed in the message. Accordingly, Network A includes descriptive information about the mobile device in the message for identifying the mobile device as the intended recipient of the device at Network B.

At block 310, a determination is made by Network B as to whether the intended recipient of the voice mail (e.g. mobile device) is active. At block 312, if the mobile device is active on Network B, the voice mail indication is sent to the mobile device. However, at block 314, if the mobile device is not active on Network B, the message indication is cached and is sent to the mobile device the next time the mobile device becomes active on Network B. Network B sends the voice mail indication when the mobile device becomes active on Network B. However, a problem arises when the mobile device powers up in Network A instead of B, where the forwarded message is awaiting from Network A. The mobile device powering up in Network A and receiving the message at Network A then moves to Network B and receives the same message; that is, a stale message. Accordingly, the mobile device decodes the descriptive information contained in the message indication to determine if the message indication is stale. If the message indication is stale, the mobile device may automatically discard the voice mail.

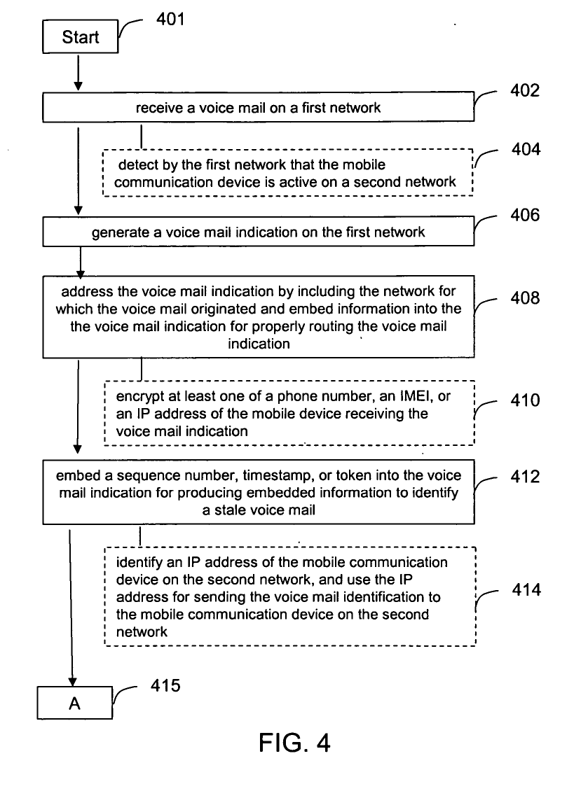

Referring to FIG. 4. a method 400 for voice mail notification in a loosely coupled environment is shown. When describing the method 400, reference will be made to FIGS. 1, 2 and 3, although it must be noted that the method 400 can be practiced in any other suitable system or device. Moreover, the steps of the method 400 are not limited to the particular order in which they are presented in FIG. 4. The inventive method can also have a greater number of steps or a fewer number of steps than those shown in FIG. 4.

At step 401, the method can start. At step 402, a voice mail notification can be received on a first network. For example, referring to FIG. 1, Network A 120 receives a voice mail for the mobile device 140. At Step 404, the first network detects if the mobile device is active on a second network. For example, referring to FIG. 1, Network A determines the mobil device 140 is active on Network B, but due to the loosely connected network, mobile device 140 is unable to receive voice mail indications directly from Network A. At step 406, a first network generates a voice mail indication to be sent to the mobile device 140. For example, referring to FIG. 1, Network A creates a plain-text token to identify the message, for example by including “VOICEMAIL” in a send field of an email. Notably, Network B exposes an interface (such as email) to send the “text” message to the phone. This is necessary since the networks are “loosely coupled,” and each network does not have knowledge of whether or not the subscriber unit is registered in the other network.

At step 408, a voice mail indication is addressed by including the network for which the voice mail originated. Descriptive information is embedded into the voice mail indication for properly routing the voice mail indication. For example a user's own ID (e.g. telephone number, PTT ID, or IP address) is included in the destination field or within the voice mail indication itself to minimize false indications. For example, referring to FIG. 1, Network A 120 identifies a source of the voice mail being sent to the message service 110. For example, the source can be identified by an IP address or a host name. Network A 120 can include the source information within the voice mail identification to inform Network B and/or the mobile device the source of the voice mail. Accordingly, the mobil device 140 can count this information and indicate to a user of the mobil device 140 how many voice mails are awaiting in which system—e.g. 3 voice mails in GSM, 2 voice mails in iDEN, and 5 voice mails in WLAN. The descriptive information can also be encrypted to prevent spoofing by unauthorized 3^{rd} party entities.

At step 412, a sequence number, a timestamp, or a token can be embedded into the voice mail indication for producing an embedded information to identify a stale voice mail. For example, referring to FIG. 1, Network A attaches a timestamp or sequential number to the message to identify the particular voice mail indication. This information is encrypted using the IMSI or. other identifier that is unique to the mobile device. For example, referring to FIG. 1, Network A appends a known token plus a new voice mail count. This information can be encrypted using the IMSI or other identifier that is unique to the mobile device 140. In an alternative arrangement, the encryption can be replaced with a hash which is significantly shorter than block encrypted messaging. The hash permits a receiver of the message to verify that the message is authenticated.

In one aspect, at step 414, an IP address of the mobile communication device on the second network can be identified which can be used for sending the voice mail identification to the mobile device on the second network. For example, referring to FIG. 1, Network A can determine the IP address of the mobil device 140 on Network B by inquiring Network B for this information. In one arrangement, the information can be communicated over the network using a push-to-talk (PTT) channel. In another arrangement, the mobile IP routing tables in the mobil device 140 and the MIP foreign agent (in WLAN network A) are mapped to a MIP home agent (in GSM network B) to allow back and forth voice mail notifications.

The voice mail indication can be in the form of an SMS message between a WLAN network and an SMPP server on a GSM network. Referring to FIG. 1, Network A can add the user's phone number to the SMS message. In certain situations, this can prevent misdirected messages from falsely signaling a voice mail indication. For multi-mode devices such as a (CDMA/IDEN/GSM+WLAN) phone, the descriptive information helps discriminate voicemail indications from multiple sources. Network A also adds the caller's phone number to the SMS message to permit user to auto-dial phone. In one arrangement, Network A also adds Cyclic Redundancy Checks (CRC) to provide verification before performing a decryption. An exemplary message format is presented:

<prefix string>: VOICEMAIL
<user's phone number>: 9547235511
<caller's phone number>: +442070190810
<unread count>: 3
<CRC16>: ABCD
<SHA-1 hash>: 13A977F5B333EA123FAB

For example, referring to FIG. 1, where Network A represents an WLAN and Network B represents a GSM network. The mobil device 140 represents a dual mode phone supporting both WLAN and GSM. Network A communicates to Network B using SMS messages as described above to send voice mail indications to the dual mode phone when the phone is camped on GSM. The SMS can include the IMSI, an address of a proxy in the WLAN and the voice mail notification itself. The message format above can use the colon to separate fields after the prefix, and the comma for extension formatting. As another example, the mobil device 140 browses the Web both in WLAN mode and in GSM mode using GPRS. The mobil device 140 is notified of pending voice mails by to sending GSM voice mail messages to the phone's IP address. The IP routing is an operable solution for sending voice mail notifications when the handset is active or camped on either network. The term camped means the mobil device 140 is either active or was last registered on a particular network.

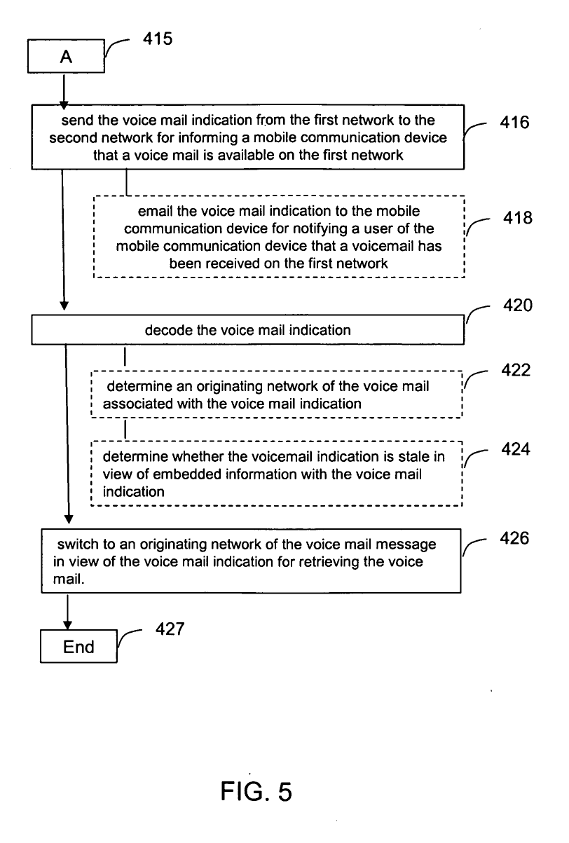

At step 416 of FIG. 5, the voice mail indication can be sent from the first network to the second network for informing a mobile communication device that a voice mail is available on the first network. For example, referring to FIG. 1, Network A sends the message over a public transport that has been opened up by Network B. Most cellular networks generally have an SMTP gateway that links with their SMS system. In one particular case, Network A sends the information in the form of an email. For example,,as shown by step 418, the first network can email the voice mail indication to the mobile communication device for notifying a user of the mobile communication device that a voicemail has been received on the first network. For example, referring to FIG. 1, Network A can email the voice mail indication directly through Network B to mobile device 140 which is active on Network B. Network B receives this message and then delivers the email to the mobile device 140. In the case of GSM, for example, the message would be delivered as an SMS.

At step 420, the voice mail indication can be decoded. For example, at step 422, the mobile device determines an originating network of the voice mail from the voice mail indication. As another example, at step 424, the mobile device determines whether the voicemail indication is stale in view of embedded information with the voice mail indication. For example, referring to FIG. 1, the mobil device 140 receives the message from Network B 130. The mobile device 140 parses the message to look for a token inserted in the “send” field of an email. Recall in step 404, that Network A 120 creates a plain text the token “VOICEMAIL” in a send field of an email. If the mobil device 140 sees this token, it decrypts the rest of the message in view of a unique identifier (e.g. IMSI) contained within the embedded information. The decrypted data is searched for the token appended in the “send” field. If the token is found, a count is extracted from the voice mail message. A sequence number from the previous voicemail indication is checked. If the sequence number is greater than the last voicemail indication's sequence number, then the user is notified of the new voicemail status. Otherwise, the indication is considered to be “stale,” and the message is discarded. If any of the token comparisons fail in steps 2-4, the message is treated as any normal text message. The sequence number is used to eliminate false indications that have been cached by one of the networks.

A user interface on the mobil device 140 can present an icon on a display indicating that voice mail has been received and is available on a network. The display indicates to a user how many voice mails are available and in which originating network said voice mails are available. The user interface presents at least one icon associated with an originating network of the voice mail in view of the voice mail indication. The icon can produce a flashing behavior, an audible behavior, or textual behavior for notifying a user that a voice mail is available.

At step 426, an originating network of the voice mail message can be switched to in view of the voice mail indication for retrieving the voice mail. For example, referring to FIG. 1, the mobil device 140 on network B (GSM) dials into the voice mailbox identified by the embedded information of the SMS message for retrieving the voice mail.

Embodiments of the invention also overcome issues in voice mail notification concerning the receipt of stale voice mails. For example, a problem arises when a voicemail server sends an indication to a network that caches the indication (such as GSM) when the mobile device is powered off or otherwise unreachable. The mobile device is then powered up in a different network (such as WLAN). While in the new network, the status of the voicemail box changes, and an update is sent directly to the mobile communication device. The mobile device then roams into GSM for receiving the cached indication, which contains stale information.

Where applicable, the present embodiments can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for email notification for use with a network and a mobile device comprising:
receiving a voice mail on a first network;
generating a voice mail indication on said first network; and
sending said voice mail indication from said first network through said second network to inform a mobile device that a voice mail is available on said first network.

2. The method of claim 1, further comprising detecting by the first network that said mobile device is active on a second network.

3. The method of claim 1, wherein said step of sending further comprises identifying an IP address of said mobile device on said second network, and using said IP address for sending said voice mail identification to said mobile device on said second network.

4. The method of claim 1, wherein said step of generating further comprises addressing said voice mail indication by including the network for which said voice mail originated and embedding information into said voice mail indication for routing the voice mail indication.

5. The method of claim 1, wherein the embedded information comprises encrypting at least one of a phone number, an IMEI, an IP address, or other identifier unique to the the mobile device receiving the voice mail indication.

6. The method of claim 1, wherein said step of sending further comprises embedding a sequence number, timestamp, or token into said voice mail indication for producing embedded information to identify a stale voice mail.

7. The method of claim 1, wherein said step of sending further comprises emailing said voice mail indication to said mobile device for notifying a user of said mobile device that a voicemail has been received on said first network.

8. The method of claim 7, wherein said step of sending further comprises appending a token plus a voice mail count in the voice mail identification.

9. The method of claim 7, further comprising decoding the voice mail indication by:
determining an originating network of said voice mail associated with said voice mail indication; and
determining whether said voicemail indication is stale in view of embedded information with said voice mail indication,
wherein said voice mail indication on said second network is received through an IP address assigned to the mobile device by said second network.

10. A mobile device on a network comprising:
a receiver for receiving a voice mail indication;
a decoder for determining an originating network of a voice mail associated with said voice mail indication; and
a user interface for indicating a number of voice mails received on an originating network in view of said voice mail indication.

11. The mobile device of claim 10, wherein said display indicates to a user how many voice mails are available and in which originating network said voice mails are available.

12. The mobile device of claim 10, wherein said user interface presents at least one icon associated with an originating network of said voice mail in view of said voice mail indication.

13. The mobile device of claim 12, wherein said icon exhibits one of a flashing behavior, an audible behavior, or textual behavior for notifying a user that a voice mail is available.

14. The mobile device of claim 12, further comprising switching to an originating network of said voice mail message in view of said voice mail indication for retrieving said voice mail.

15. A system for voice mail notification comprising:
a first network for generating and sending a voice mail indication; and
a second network for receiving said voice mail indication;
wherein said second network informs a mobile device that is active on said second network that a voice mail is available on said first network.

16. The system of claim 15, wherein said second network informs a mobile device by sending a voice mail indication to an IP address that is assigned to said mobile device by said second network.

17. The system of claim 15, wherein said first network embeds a sequence number, timestamp, or token into said voice mail indication.

18. The system of claim 16, wherein either said first or second network emails said voice mail indication to said IP address of said mobile device on second network for notifying a user of said mobile device that a voicemail has been received on said first network.

19. The system of claim 15, wherein said first network determines whether said mobile device is active on said second network.

20. The system of claim 15, wherein said second network generates an identifier in said voice mail indication to indicate that a voice mail is stale.
